(19) United States
(12) Patent Application Publication
(10) Pub. No.: US 2018/0076607 A1
(43) Pub. Date: Mar. 15, 2018

(54) Cable Splicing Support Apparatus and Methods of Using the Same

(71) Applicant: Derrick Chatman Electric LLC, Morrisville, PA (US)

(72) Inventor: Derrick Chatman, Morrisville, PA (US)

(73) Assignee: Derrick Chatman Electric LLC, Morrisville, PA (US)

(21) Appl. No.: 15/561,050

(22) PCT Filed: Mar. 23, 2016
(86) PCT No.: PCT/US16/23714

§ 371 Date: Sep. 23, 2017

Related U.S. Application Data
(60) Provisional application No. 62/137,431, filed on Mar. 24, 2015.

(51) Int. Cl. H02G 3/32; H02G 3/00; H02G 1/14; H01R 4/38; F16M 11/04

(52) U.S. Cl. CPC H02G 3/32; H02G 3/263; H02G 1/005; H01R 4/38; F16M 11/046; H02G 1/14

(57) ABSTRACT

A cable splicing support apparatus for securing a cable to be spliced in enclosed space, a kit of parts for providing such apparatus, and method of using same are provided herein.

### CROSS-REFERENCE TO RELATED APPLICATIONS

This International Application claims the benefit of priority to U.S. Provisional Application No. 62/137,431, filed Mar. 24, 2015, the entire contents of which are incorporated herein by reference.

### FIELD OF THE INVENTION

The present invention relates generally to a device for securing a cable and more particularly, but not exclusively, to a cable splicing support apparatus for securing a cable in an enclosed space, a kit of parts for providing such apparatus, and methods of using the same.

### BACKGROUND OF THE INVENTION

Electrical transmission cables are often placed below-ground in enclosed spaces, such as conduits or tunnels, in order to protect the cables and remove them from sight. These cables often may be laid in segments and can require splicing as new sections of cable are added to previously installed cable sections. Conduits are often confined spaces that may be wet or fouled with dirt and debris. During the splicing process, a cable splice may be compromised if the exposed contents of a cable segment become wet or fouled by, for example, contacting a wet or fouled surface of the conduit. Accordingly, a cable segment that requires splicing should be kept away from the surfaces of the conduit in which the cable resides and supported during splicing to prevent fouling of the cable splice. However, admittance to such conduits and tunnels is often size prohibitive and may prevent workers from accessing the cables that may require splicing.

Accordingly, there is a need in the field for a portable device that may support a cable to be spliced in an enclosed space to allow a worker to address the exposed contents of the cable without the risk of wetting or fouling of the cable.

### SUMMARY OF THE INVENTION

The present invention addresses the needs in the field by providing a cable splicing support apparatus, and kit, for securing a cable in an enclosed space.

In a first aspect, the present invention includes a cable splicing support apparatus for securing a cable in an enclosed space. The apparatus may include an adjustable support bar that may comprise a first support member, a second support member, and an extension rod. The first support member may have a first shaft and a first engagement portion that may include a first foot configured to removably engage a first surface of an enclosed space. The second support member may slidably engage with the first support member and may include a second shaft and a second engagement portion having a second foot configured to removably engage a second surface of an enclosed space, wherein the first engagement portion and second engagement portion may be aligned in diametric opposition. The extension rod may be configured to expand the adjustable support bar and removably engage the first foot and second foot with the first and second surfaces of the enclosed space.

The apparatus may further include a support locking member that may be configured to releasably lock the first and second support members in fixed engagement. In addition, the apparatus may include a splicing platform that may be engaged with at least one of the first and second support members and configured to removably secure a cable. The platform may comprise a mounting bracket that may be configured to connect with at least one of the first and second support members.

In another aspect, the present invention may include a cable splicing support kit that may have component parts capable of being assembled within an enclosed space at a cable that requires splicing for supporting the cable. The kit may include a first support member, a second support member, an extension rod, a support locking member, and a cable splicing platform. The first support member may have a first shaft and a first engagement portion that may have a first foot configured to removably engage a surface of an enclosed space. The second support member may be adapted to be slidably engaged with the first support member and thereby provide an adjustable support bar. The second support member may also have a second shaft and a second engagement portion having a second foot adapted to removably engage a surface of an enclosed space, wherein the first engagement portion and second engagement portion are adapted to be aligned in diametric opposition.

The kit may include an extension rod may be configured to expand the adjustable support bar and adapted to removably engage the first foot and second foot with the first and second surfaces of the enclosed space. Moreover, the kit may include a support locking member that may be adapted to releasably lock the first and second support members in fixed engagement. Additionally, the kit may include a cable splicing platform adapted to be engaged with at least one of the first and second support members and configured to removably secure a cable. The platform may include a mounting bracket adapted to be connected with at least one of the first and second support members.

Regarding the kits of the invention, the present invention may include a splicing kit to aid in making medium voltage to high voltage splices in enclosed spaces (e.g., manholes and transformers). Medium and high voltage splices may need to be cleaned, prepped, and/or otherwise made ready to splice and the apparatuses and kits of the invention may aid in this process. By being able to clamp down and hold the cables to be spliced while prepping them, the cable splicer's job is made easier and makes the potential for failure of the cable or splice due to water or dirt more unlikely. Indeed, there are many variables when dealing with the splicing of cables in enclosed spaces (e.g., manholes and transformers), including the enclosed space's size, width, height, cleanliness, and/or moisture.

By using the apparatuses, kits for providing the same, or methods as set forth herein, the described needs associated with cable splicing known in the field are answered.

### BRIEF DESCRIPTION OF THE DRAWINGS

The foregoing summary and the following detailed description of the exemplary embodiments of the present invention may be further understood when read in conjunction with the appended drawings, in which:

FIG. 1 is an exploded view of a cable splicing support in accordance with an exemplary embodiment of the present invention.

FIG. 2 is a perspective view of the cable splicing support in accordance with an exemplary embodiment of the present invention.

FIG. 3 is a perspective view of the cable splicing support in accordance with an exemplary embodiment of the present invention of FIG. 2 shown with a lamp attachment.

FIG. 4 is a perspective view of the cable splicing support in accordance with an exemplary embodiment of the present invention of FIG. 2 shown with a tray attachment.

FIG. 5 is a side view of the cable splicing support in accordance with an exemplary embodiment of the present invention of FIG. 2 shown in an exemplary deployment of the support in an enclosed space at a cable to be spliced.

### DETAILED DESCRIPTION OF THE INVENTION

The present invention allows a worker or splicer to be able to support a cable to be spliced and keep the cable clean during the splicing process. Keeping a cable to be spliced clean is an important factor in splicing. The apparatus, kits, and methods of use described herein provide a splicer with the ability to use both hands to prepare cables for splicing without the worry that the cable may fall to the bottom of the enclosed space or manhole and collect any debris that could ruin or otherwise foul the cable.

The present invention relates to a cable splicing apparatus for securing a cable in an enclosed space, a kit that includes the elements of such apparatus, and methods of using the same. As used herein, an “enclosed space” may be defined as a space or area at least partially surrounded by a wall or enclosure and is capable of enclosing a cable or pipe. For example, the “enclosed spaces” of the invention include, but are not limited to, manholes, conduits, tunnels, transformers, or pipes. The cross section of the “enclosed space” may be, for example, a symmetric cross section (e.g., a circular cross section or a square cross section) or an asymmetric cross section.

As used herein, the term “cable” may be defined as one or more wires (e.g., metallic wires or fiber optic wires) that are covered or bound together by a sleeve, insulation, jacket, or a combination thereof. For example, the cable may be an electric cable (e.g., a medium voltage cable or high voltage cable), a fiber optic cable, or a telecommunication cable. In certain aspects, the cable is an electric cable, such as a medium voltage cable or high voltage cable.

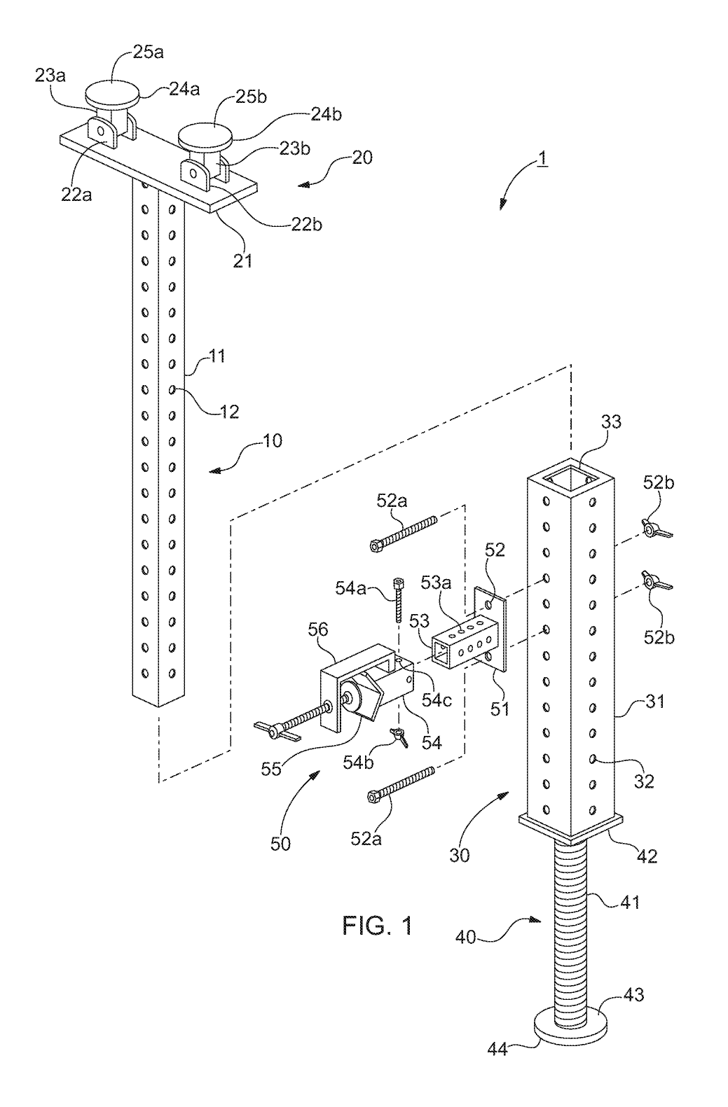

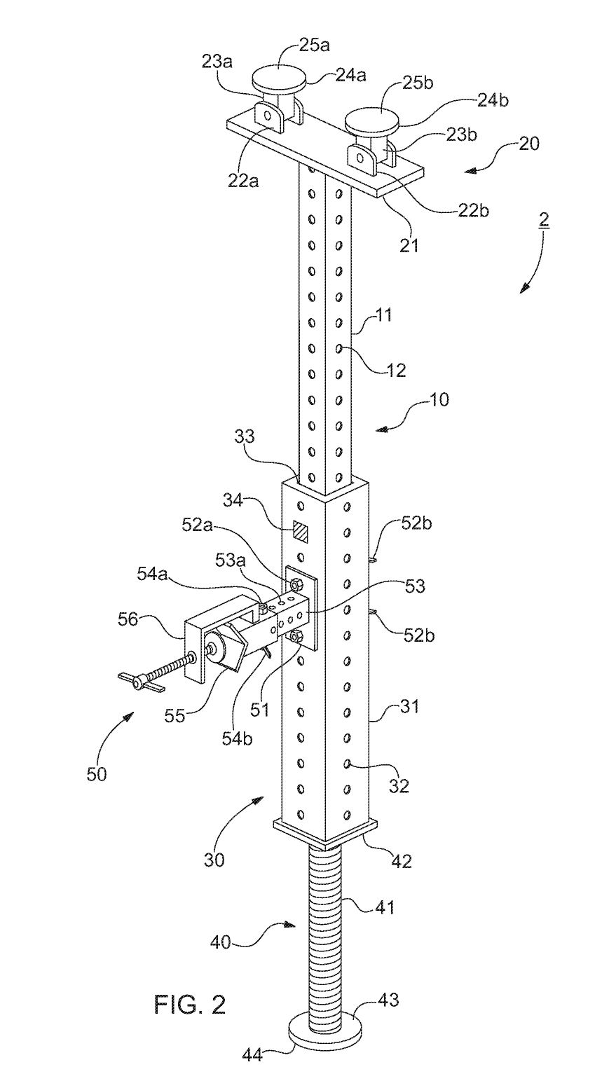

Referring now to the figures, wherein like elements are numbered alike throughout, FIGS. 1 and 2 demonstrate certain aspects of the present invention. FIG. 1 provides an exploded view of a cable splicing support apparatus 1 of the invention that demonstrates the component parts of an exemplary apparatus. FIG. 2 provides a view of an assembled cable splicing support apparatus 2 of the invention. Specifically, the apparatuses 1 and 2 may include a first support member 10, first engagement portion 20, a second support member 30, second engagement portion 40, and cable splicing platform 50. Furthermore, in apparatuses 1 and 2 of the invention, for example, the first support member 10, first engagement portion 20, second support member 30, and second engagement portion 40 may constitute an adjustable support bar.

The first support member 10 may include a first hollow shaft 11 and a first engagement portion 20 that may be disposed at one end of the first hollow shaft 11 that may be provided to engage a first surface of an enclosed space. The first hollow shaft 11 may include one or more holes 12 that may be spaced axially and/or radially about the hollow shaft 11. Alternatively, the first hollow shaft 11 may not have holes 12 and, instead may be smooth or may be limited to one set of axial and/or radial holes 12 about the hollow shaft 11. The first engagement portion 20 may also include a foot mounting bracket 21 for mounting a first foot 24, which may be one or more feet (e.g., 24a and 24b). The feet 24a and 24b may allow the apparatus to removably engage with a surface of an enclosed space. The foot mounting bracket 21 may be a rod or a bar. Preferably, the foot mounting bracket 21 may be a flat bar, which may be a 0.5 inch to 2 inch flat bar (e.g., 1 inch) that is attached to one end of the first hollow shaft 11. In certain aspects, the foot mounting bracket 21 may be welded or otherwise fixably attached to the hollow shaft 11.

The one or more feet 24 may include between one and three feet. However, in preferred aspects of the invention, the foot mounting bracket 21 includes two feet 24a and 24b. The feet 24a and 24b may be mounted at the foot mounting bracket 21 via a post, for example, or may be otherwise fixed to the foot mounting bracket 21. In preferred aspects, the feet 24a and 24b are pivotally mounted to the foot mounting bracket 21 via pivots 22a and 22b, respectively, which are then attached to the feet 24a and 24b through connectors 23a and 23b. The first feet 24a and 24b are preferably mounted pivotally to allow for the apparatus to accommodate different cross sections in the enclosed space. Indeed, by mounting the feet 24a and 24b pivotally, the feet may engage with a curved interior surface of a tunnel or manhole and pads 25 of the feet 24 may be flush against the curved interior surface, for example. Regarding the pads 25a and 25b of first feet 24a and 24b, respectively, such pads may be metallic or they may be deformable pads that may include a polymeric material. Preferably, the pads 25a and 25b include a polymeric material (e.g., rubber). In particularly preferred embodiments, the pads 25a and 25b may be made of rubber.

In certain aspects, the first support member may be a tube that may have a width of about 1 to 3 inches. Moreover, the first support member may have a length of about 3 to 7 feet long. In preferred aspects, the first support member may include a square tube that has a width of about 1.25 inches (1.25×1.25 inches) having a length of about 5 feet.

The second support member 30 may have a second hollow shaft 31. Upon connection of the first and second support members 10 and 30, respectively, the members 10 and 30 are designed such that one member slides into the other to allow the apparatus to expand and contract as needed by the user of the apparatus. For example, the second hollow shaft 31 may have an opening 33 that is wider than the first hollow shaft 11, allowing the first support member 10 to slide into the interior of the second hollow shaft 31. By this mechanism, the second support member 30 may be said to slidably engage with the first member 10.

In certain aspects, the second support member may be a tube that may have a width of about 1 to 3 inches. Moreover, the second support member may have a length of about 3 to 7 feet long. In preferred aspects, the second support member may include a square tube that has a width of about 1.5 inches (1.5×1.5 inches) having a length of about 5 feet.

The second hollow shaft 31 may include one or more holes 32 that may be spaced axially and/or radially about the hollow shaft 31. Alternatively, the first hollow shaft 31 may not have holes 32 and, instead may be smooth or may be limited to one set of axial and/or radial holes 32 about the hollow shaft 31.

The second support member 30 may also include a second engagement portion 40 for engaging with a second surface of the enclosed space that is across from the first surface. For example, the first engagement portion 20 may removably engage with the ceiling of a conduit having one or more cables while the second engagement portion 40 removably engages with the floor of the conduit. Alternatively, the first engagement portion 20 may removably engage with one vertical wall of a manhole while the second engagement portion 40 removably engages with the opposing vertical wall of the manhole. Indeed, the first engagement portion 20 and second engagement portion 40 may be aligned or positioned in diametric opposition when arranging the apparatus 1 within an enclosed space.

The second engagement portion 40 may have an extension rod 41 that terminates in a foot 43 that may removably engage a surface of an enclosed space. The extension rod 41 attaches to the second hollow shaft 31. The second hollow shaft 31 may have an extension rod locking member 42 that connects the second hollow shaft 31 to the extension rod 41 and allows the extension rod 41 to be releasably locked in fixed engagement with respect to the hollow shaft 31. At least a portion of the extension rod 41 may be disposed within the second hollow shaft 31. The extension rod 41 may extend from the hollow shaft 31 to expand the apparatus 1.

The extension rod 41 may have a length of about 6 to 18 inches, but, preferably, about 12 inches.

The extension rod locking member 42 may be any device or instrument that may lock the second hollow shaft 31 and extension rod 41 in fixed engagement. In one embodiment, the extension rod 41 may have one or more grooves or a rack and the extension rod locking member 42 may include a retractable pawl that may fit into the groove(s) or rack on the extension rod 41 to lock the second hollow shaft 31 and extension rod 41 in fixed engagement. In another embodiment, the extension rod locking member 42 may include a locking bolt that is threaded through a surface of the second hollow shaft 31 that is perpendicular to the axis of the locking bolt and abuts a surface of the extension rod 41. The locking bolt may be tightened against the extension rod 41 to lock the second hollow shaft 31 and extension rod 41 in fixed engagement. For example, the locking bolt may be a set screw or a pin. In a further embodiment, the extension rod 41 may be threaded and the extension rod locking member 42 includes a jack bolt that may be used to both adjust the length of extension of the extension rod 41, as well as lock the second hollow shaft 31 and extension rod 41 in fixed engagement. Alternatively, where both the hollow shaft 31 and extension rod 41 are round pipe, the extension rod locking member 42 may be a compression fitting. Furthermore, the second engagement portion 40 may include a scaffold screw with a handle that connects the foot 43 to the second hollow shaft 31.

In certain instances, both the second hollow shaft 31 and extension rod 41 may have one or more apertures and, for example, a plurality of apertures spaced axially and radially about the shaft 31 and rod 41. The extension rod locking member 42 may then include a pin, which may include a safety latch, that may pass through an aperture of the second hollow shaft 31 and the extension rod 41 to lock the second hollow shaft and extension rod in fixed engagement. Alternatively, the extension rod locking member 42 may be a threaded bolt that is fixed via a nut (e.g., a wing nut).

In some embodiments, extension rod locking member 42 may include a device for expanding and/or retracting the extension rod 41, such as, for example, a hand crank or an electric motor.

The second engagement portion 40 may also include a second foot 43 that may removably engage with a second surface of an enclosed space. The second foot 43 may include a pad 44. Regarding the pad 44 of second foot 43, the pad may be metallic or may be a deformable pad that may include a polymeric material. Preferably, the pad 44 includes a polymeric material (e.g., rubber). In particularly preferred embodiments, the pad 44 may be made of rubber.

The apparatus 1 may also include one or more cable splicing platforms 50 that may be connected to or otherwise engaged with the first and/or second support members 10 and 30, respectively. The cable splicing platform 50 allows a user to retain or secure the movement of a cable to be spliced. After the user has finished operating on the cable, the cable may be removed from the cable splicing platform. In certain aspects, the cable splicing platform 50 may be permanently fixed to the first support member 10 or the second support member 30. However, in preferred embodiments, the cable splicing platform 50 may be removably or temporarily engaged with a hollow shaft of the first support member 10 or second support member 30. Additionally, where several cables require splicing multiple cable splicing platforms 50 may be affixed to the first and/or second support members 10 and 30. For example, 2 to 5 cable splicing platforms 50 may be provided.

Generally, the cable splicing platform 50 may include a mounting bracket 51, a bracket arm 53, a cable holder connector 54, a cable holder 55, and a cable keeper 56. For example, the cable splicing platform 50 may include a mounting bracket 51 that may connect the cable splicing platform 50 to the first support member 10 or second support member 30.

The mounting bracket 51 may be any device or element that may be used to removably fix the cable splicing platform 50 to the first support member 10 or second support member 30. The mounting bracket may be a clamp that fits about the first support member 10 or second support member 30. For example, mounting bracket 51 may include a clamp having a screw or locking bolt that abuts a surface of the first hollow shaft 11 or second hollow shaft 31 that is perpendicular to the axis of the screw or locking bolt. Indeed, the clamp may include one or more set screws. The mounting bracket 51 may include a flat bar having one or more apertures 52 (e.g., two apertures) that align with apertures 12 or apertures 32; or a C-channel bar substantially matching the shape of the first hollow shaft 11 or second hollow shaft 31 having one or more apertures 52 (e.g., two apertures) that align with apertures 12 or apertures 32. Additionally, where the mounting bracket 51 includes a C-channel bar or flat bar having apertures 52, the mounting bracket may include bolts 52a that pass through apertures 52, the apertures 12 and/or 32, and may be secured with locking latches or nuts 52b (e.g., wing nuts). For example, the mounting bracket 51 may be a 2 to 4 inch C-channel that is about 4 inches long and may straddle the first hollow shaft 11 or second hollow shaft 31. Moreover, such a C-channel may have a coupling welded to it for a pipe having a pipe claim affixed thereto that may hold the C-channel (i.e., mounting bracket 51) to the first hollow shaft 11 or second hollow shaft 31.

The cable splicing platform 50 may include a cable holder 55 that may support or cradle a cable. For example, the cable holder 55 may be a flat plate upon which a cable may be placed. Alternatively, the cable holder 55 may have a cross-section that may be a v-shaped cross section, a semi-circular cross section, or a semi-elliptical cross section. The cable holder 55 may be connected directly to the bracket arm 53. Preferably, the cable holder 55 may be connected to the bracket arm 53 via a cable holder connector 54. Indeed, the cable holder connector 54 may be slidably connected to the bracket arm 53 such that the bracket arm 53 slides into the hollow body of the cable holder connector 54. In certain embodiments, the bracket arm 53 and/or the cable holder connector 54 may be tubes having a square or circular cross section. Furthermore, each of the bracket arm 53 and cable holder connector 54 may have one or more apertures spaced along the surfaces of the bracket arm 53 and/or cable holder connector 54.

For example, the bracket arm 53 may have an aperture 53a. The cable holder connector 54 may then be slid over the bracket arm 53 such that the arm 53 is received within the body of the cable holder connector 54. The cable holder connector 54 may have an aperture 54c. A bolt 54a may be passed through the aperture 54c, as well as the aperture 53a, and may be secured with a locking latch or nut 54b (e.g., wing nut). Alternatively, the cable holder connector 54 may be secured or otherwise engaged with the bracket arm 53 via a locking bolt that is threaded through a surface of the cable holder connector 54 that is perpendicular to the axis of the locking bolt and abuts a surface of the bracket arm 53. The locking bolt may then be tightened against the bracket arm 53 to lock the cable holder connector 54 and the bracket arm 53 in fixed engagement. For example, the locking bolt may be a set screw or a pin.

As is apparent in FIGS. 1 and 2, the orientation of the cable holder connector 54 may be adjusted with respect to the bracket arm 53. Indeed, the cable holder connector 54 may be rotated 90° with respect to the bracket arm 53 and then locked or engaged, as described above, depending on the position and alignment of the cable to be secured by the apparatus 1 and 2. Moreover, by way of the cable holder connector 54, the cable holder 55 may be rotated about the bracket arm 53 and may be rotated 90° or 180°, or in 90° increments.

The cable splicing platform 50 may further include a cable keeper 56 that may be attached to one or both of the cable holder 55 and cable holder connector 56. The cable keeper 56 may operate with the cable holder 55 to releasably secure a cable to the splicing platform 50. As shown in FIGS. 1 and 2, the cable keeper 56 may be attached to the cable holder connector 54 and may be positioned on the platform 50 provide an opposing pressure to a surface of a cable at the cable holder 55 to maintain the cable's position and prevent undesired movement of the cable. For example, the cable keeper may be a clamp (e.g., a screw clamp as shown in FIGS. 1 and 2). Alternatively, the cable keeper may include an arm that may extend over a cable seated at the cable holder 55 where the cable holder 55 further includes a latch (e.g., a compression latch) that may releasably lock the arm in place in order to maintain the cable's position and prevent undesired movement of the cable.

The cable holder 55 may, for example, be a 1 to 3 inch angle having a v-cross section. Preferably, the cable holder 55 is a 2 inch angle having a v-cross section. Moreover, the cable holder 55 may be about 4 to 10 inches long, but, preferably, about 8 inches long. In addition, the cable holder connector 54 may have a width of about 1 to 3 inches, but, preferably, about 1.5 inches. The cable holder connector 54 may further have a length of about 4 to 10 inches, but, preferably, about 8 inches. The bracket arm 53 may, for example, have a width of about 1 to 3 inches, but, preferably, about 1.25 inches. The bracket arm 53 may further have a length of about 4 to 10 inches, but, preferably, about 8 inches.

In some embodiments, the cable holder 55 may be a hook. In other embodiments, the cable holder 55 may be a ring that includes a clasp portion for allowing a cable to be placed in the ring. In other embodiments, the cable holder 55 may include a spring loaded clamp. In still other embodiments, the cable holder 55 may be a flexible, semi-rigid arm (which may or may not be segmented) that may be wrapped around a cable to secure it at an apparatus of the invention.

Regarding FIGS. 1 and 2, the second hollow shaft 31 may have a support shaft receiver 33. As shown specifically in FIG. 2, the first hollow shaft 11 may be inserted into the second hollow shaft 31 at the support shaft receiver 33 to slidably engage the second hollow shaft 31 with the first hollow shaft 11. Indeed, the length of the cable splicing support apparatus 2 may be adjusted by sliding the first hollow shaft 11 into or out of the second hollow shaft 31. Moreover, the slidably engaged first and second hollow shafts 11 and 31, respectively, may be locked in fixed engagement by implementing a support locking member 34 at the second hollow shaft 31 that may releasably lock the first and second hollow shafts 11 and 31, respectively.

The support locking member 34 may be any device or element that may be used to fix the engagement of the first and second hollow shafts 11 and 31 with respect to one another and provide the connected adjustable support bar. For example, a surface of the first hollow shaft 11 may have one or more grooves or a rack and the second hollow shaft 31 may have a support locking member that includes a retractable pawl that may fit into the groove(s) or rack on the first hollow shaft 11 in fixed engagement. In another embodiment, the support locking member 34 may include a locking bolt at the second hollow shaft 31 where the locking bolt is threaded through a surface of the second hollow shaft 31 that is perpendicular to the axis of the locking bolt and abuts a surface of the first hollow shaft 11. The locking bolt may be tightened against the first hollow shaft 11 to lock the second hollow shaft 31 and first hollow shaft 11 in fixed engagement. The locking bolt may be, for example, a set screw. In a further embodiment, a portion of the first hollow shaft 11 may be threaded and the support locking member 34 may include a jack bolt that may be used to both adjust the length of the apparatus 2, as well as lock the first hollow shaft 11 and second hollow shaft 31 in fixed engagement. Alternatively, where both the first hollow shaft 11 and second hollow shaft 31 are round pipe, the support locking member 34 may be a compression fitting. For example, the support locking member 34 may be 2×0.25 inch pins with safety latches that may be used to fix the length of the adjustable support bar by passing through the holes 12 and 32 arranged on the first hollow shaft 11 and second hollow shaft 31.

In certain instances, both the first hollow shaft 11 and second hollow shaft 31 may have one or more apertures and, for example, a plurality of apertures spaced axially and radially about shafts 11 and 31. The support locking member 34 may then include a pin, which may include a safety latch, that may pass through an aperture of the second hollow shaft 31 and the first hollow shaft 11 to lock the first and second hollow shafts 11 and 31, respectively, in fixed engagement. Alternatively, the support locking member 34 may be a threaded bolt that is fixed via a nut (e.g., a wing nut).

In some embodiments, support locking member 34 may be replaced by one or more bolts 52a that may be used in conjunction with mounting bracket 51 to lock the first hollow shaft 11 and second hollow shaft 31 in fixed engagement.

Regarding the first and second hollow shafts 11 and 31 more broadly, such shafts may have a square cross section or a circular cross section. Preferably, the first and second hollow shafts 11 and 31 have a square cross section. Moreover, the cross sectional width of the second hollow shaft 31 may be greater than the cross sectional width of the first hollow shaft 11, thereby allowing the first hollow shaft 11 to slidably engage with the second hollow shaft 31 at the support shaft receiver 33, as described above. However, in alternative arrangements, the first hollow shaft 11 may have a cross sectional width that is greater than the cross sectional width of the second hollow shaft 31 and, in such instances, the first hollow shaft 11 may have a support shaft receiver that may receive the second hollow shaft 31. Accordingly, in such embodiments where the first hollow shaft 11 receives the second hollow shaft 31, the support locking member may instead be provided at the first hollow shaft 11.

As described herein, the adjustable support bar (i.e., the first support member 10 slidably engaged with the second support member 30) may, in certain instances have a square cross section with one foot 43 on one end and two feet 24a, 24b on the other end. Fully assembled, the adjustable support bar may extend to a length of about 3 to 14 feet, depending upon the lengths of the first support member 10 and second support member 30, as described herein. In preferred aspects, the adjustable support bar may extend to a length of about 5 feet to about 11 feet.

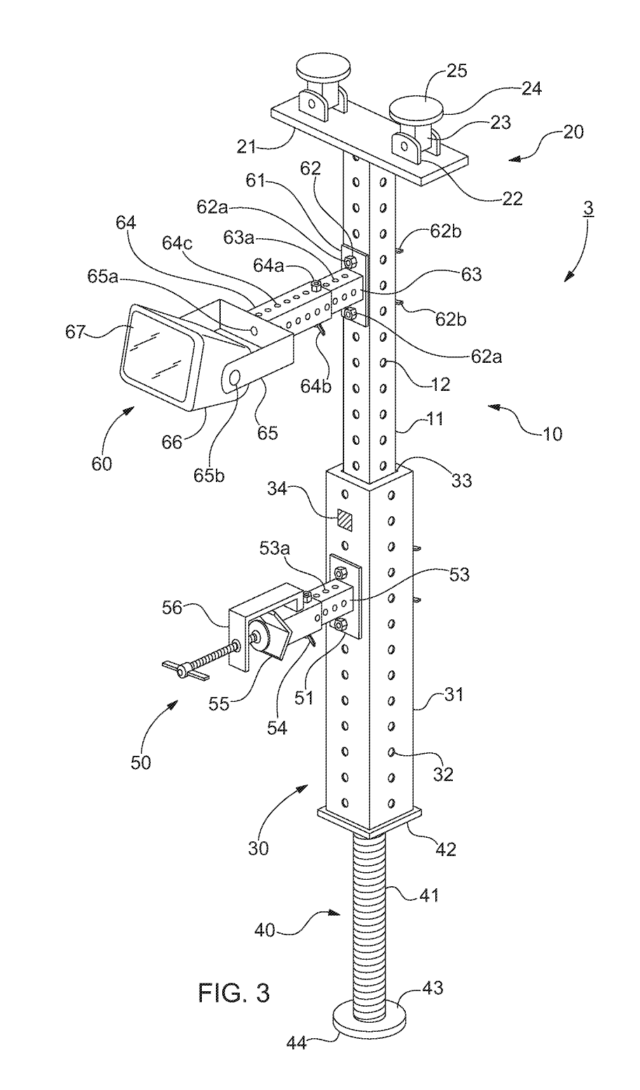

As shown in FIG. 3, another embodiment of the apparatus 3 may include, for example, a lamp attachment 60. The lamp attachment 60 may generally include a lamp bracket 61, a lamp arm 63, a lamp connector 64, an adjustment member 65, and a lamp assembly 66 that may include a lens 67.

The lamp bracket 61 may be any device or element that may be used to removably fix the lamp attachment 60 to the first support member 10 or second support member 30. The lamp bracket may be a clamp that fits about the first support member 10 or second support member 30. For example, lamp bracket 61 may include a clamp having a screw or locking bolt that abuts a surface of the first hollow shaft 11 or second hollow shaft 31 that is perpendicular to the axis of the screw or locking bolt. Indeed, the clamp may include one or more set screws. The lamp bracket 61 may include a flat bar having one or more apertures 62 (e.g., two apertures) that align with apertures 12 or apertures 32; or a C-channel bar substantially matching the shape of the first hollow shaft 11 or second hollow shaft 31 having one or more apertures 62 (e.g., two apertures) that align with apertures 12 or apertures 32. Additionally, where the lamp bracket 61 includes a C-channel bar or flat bar having apertures 62, the mounting bracket may include bolts 62a that pass through apertures 62, the apertures 12 and/or 32, and may be secured with locking latches or nuts 62b (e.g., wing nuts).

The lamp attachment 60 may include an adjustment member 65 that may support a lamp assembly 66 and includes at least two pivot points (pivots 65a and 65b) that allow the lamp assembly 66 to rotate about at least two axes. For example, pivot 65a may be affixed to a cap (not shown in figures) that is located at the end of lamp connector 64, which may allow the adjustment member 65 to rotate. Alternatively, pivot 65a may be removed by welding or otherwise fixing the adjustment member 65 directly to the lamp connector 64. The adjustment member 65 may be connected directly to the lamp arm 63. Preferably, the adjustment member 65 may be connected to the lamp arm 63 via a lamp connector 64. Indeed, the lamp connector 64 may be slidably connected to the lamp arm 63 such that the lamp arm 63 slides into the hollow body of the lamp connector 64. In certain embodiments, the lamp arm 63 and/or the lamp connector 64 may be tubes having a square or circular cross section. Furthermore, each of the lamp arm 63 and lamp connector 64 may have one or more apertures spaced along the surfaces of lamp arm 63 and/or lamp connector 64.

For example, the lamp arm 63 may have an aperture 63a. The lamp connector 64 may then be slid over the lamp arm 63 such that the arm 63 is received within the body of the lamp connector 64. The lamp connector 64 may have an aperture 64c. A bolt or pin 64a may be passed through the aperture 64c, as well as the aperture 63a, and may be secured with a locking latch or nut 64b (e.g., wing nut). Alternatively, the lamp connector 64 may be secured or otherwise engaged with the lamp arm 63 via a locking bolt that is threaded through a surface of the cable holder connector 64 that is perpendicular to the axis of the locking bolt and abuts a surface of the lamp arm 63. The locking bolt may then be tightened against the bracket arm 63 to lock the lamp connector 64 and the lamp arm 63 in fixed engagement. For example, the locking bolt may be a set screw or a pin.

As is apparent in FIG. 3, the orientation of the lamp connector 64 may be adjusted with respect to the lamp arm 63. Indeed, the lamp connector 64 may be rotated 90° with respect to the lamp arm 63 and then locked or engaged, as described above, depending on the users work area and/or the position and alignment of the cable to be secured by the apparatus 3.

The lamp attachment 60 may also include a lamp assembly 66 that includes, in electrical communication, a lamp, a power source, and a switch for activating or deactivating the lamp. The lamp may be an incandescent lamp or an LED lamp. In preferred aspects, the lamp is an LED lamp. As used herein, the term “power source” refers to any device that provides electrical power from a storage medium, such as a battery. For example, power sources of the invention may include one or more lithium or standard batteries. Additionally, the lamp attachment 60 may further include a lens 67 that is fixed to the lamp assembly 66 and may be a glass lens or a plastic lens.

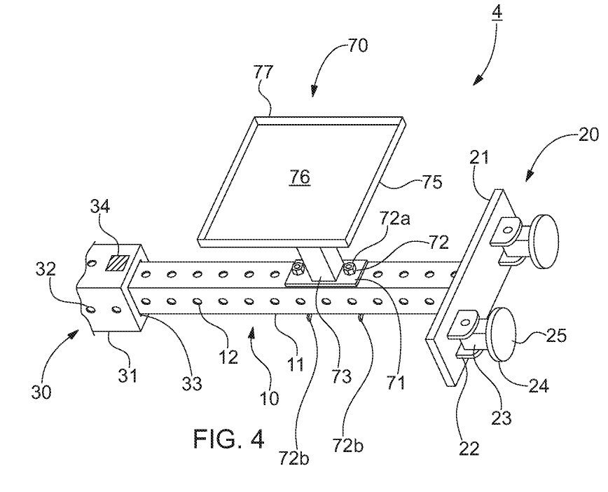

As shown in FIG. 4, another embodiment of the apparatus 4 may include, for example, a tray attachment 70 that may be fixed to either the first support member 10 or the second support member 30. For example, the tray attachment 70 may include, a tray bracket 71, an adjustable tray arm 73, and a tray 75 having a surface 76 and a lip 77.

The tray bracket 71 may be any device or element that may be used to removably fix the tray attachment 70 to the first support member 10 or second support member 30. The tray bracket may be a clamp that fits about the first support member 10 or second support member 30. For example, tray bracket 71 may include a clamp having a screw or locking bolt that abuts a surface of the first hollow shaft 11 or second hollow shaft 31 that is perpendicular to the axis of the screw or locking bolt. Indeed, the clamp may include one or more set screws. The tray bracket 71 may include a flat bar having one or more apertures 72 (e.g., two apertures) that align with apertures 12 or apertures 32; or a C-channel bar substantially matching the shape of the first hollow shaft 11 or second hollow shaft 31 having one or more apertures 72 (e.g., two apertures) that align with apertures 12 or apertures 32. Additionally, where the tray bracket 71 includes a C-channel bar or flat bar having apertures 72, the tray bracket may include bolts 72a that pass through apertures 72, the apertures 12 and/or 32, and may be secured with locking latches or nuts 72b (e.g., wing nuts).

The tray bracket 71 may be connected to the tray 75 via an adjustable tray arm 73. Adjustable tray arm 73 may have a pivot (not shown in FIG. 4) that is disposed at the end of the adjustable tray arm 73 and mounts the tray 75 to the end of the adjustable tray arm 73. The pivot on the adjustable tray arm 73 may be locked to fix the position of the tray 75, but may also allow the tray 75 to be rotated or adjusted so that the tray surface 76 may be oriented level with the ground. By allowing the tray 75 to be adjusted, a user of the apparatus 4 may orient the tray 75 such that tools or parts may be held temporarily on the tray 75.

In other aspects of the invention, the present invention may include a cable splicing kit having component parts that are capable of being assembled within an enclosed space that may form the apparatus 2 as shown in FIG. 2. Using the kit of parts (see, e.g., the parts described in FIG. 1), apparatus 2 may be assembled at a cable in need of splicing and the apparatus 2 may then be used to support the cable in the enclosed space. The kit may include, for example, (1) a first support member 10 and attached components, including the first engagement portion 20; (2) a second support member 30 and attached components, including the second engagement portion 40; (3) a support locking member 34; and (4) a cable splicing platform 50 and associated components. The kit of the invention may further include a set of instructions for assembling the apparatus 2. Moreover, the kit of the invention may include a lamp attachment 60 and/or a tray attachment 70. Additionally, the kit of the invention may include any tools needed by the person having ordinary skill in the art to assemble the apparatus 2 as described herein. The kit may also include a carrying case or bag for safely transporting the elements of the kit of the invention including, but not limited to, a foam-lined case or bag.

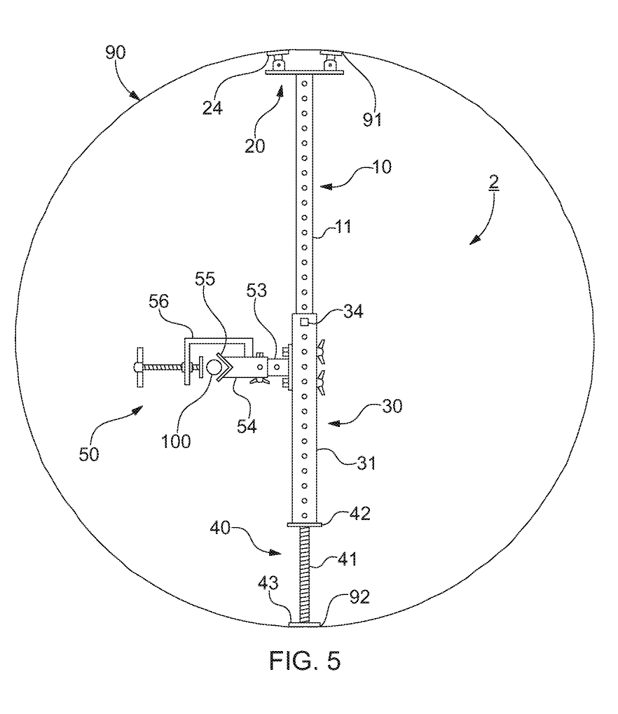

As shown in FIG. 5, the present invention further includes a method of using apparatus 2 in an enclosed space 90 having a first surface 91 and second surface 92. The method of the invention may include transporting a kit of the invention, as described herein, that includes the component parts necessary for the assembly of apparatus 2. Indeed, the method may include providing a cable splicing support apparatus (e.g., apparatus 1 or 2) proximate to a cable 100 that requires splicing in an enclosed space. Alternatively, the fully assembled device may be transported to the cable in need of splicing, rather than assembling the apparatus of the invention at the location of the cable 100.

The method may further include adjusting position of the first and second support members 10 and 30 of the device until the combination of such members (i.e., the adjustable support bar) allow the feet disposed at the first and second engagement portions 20 and 40 to be proximate to the first and second surfaces 91 and 92 of the enclosed space 90. The method may also include expanding the cable splicing support apparatus 2 until the first and second feet 24 and 44 are engaged with the first and second surfaces 91 and 92 of the enclosed space 90. This may be accomplished by adjusting the position of the first and second support members 10 and 30 with respect to one another via the support locking member 34 and/or adjusting and/or expanding the length of the extension rod 41 to ensure that the first and second feet 24 and 44 are firmly, but releasably (i.e., able to be removed from the surfaces upon disassembly of the device), engaged with the first and second surfaces 91 and 92 of the enclosed space 90 to provide a stable platform for cable splicing.

The method may also include the step of securing the cable 100 to be spliced at the cable splicing platform 50 by first placing the cable 100 at the cable holder 55 and then securing or immobilizing the cable 100 with the cable keeper 56. After the cable 100 is secured to the apparatus 2, the user may, for example, begin working and splicing the cable 100 to another length of cable.

The following example describes the invention in further detail. This example is provided for illustrative purposes only, and should in no way be considered as limiting the invention.

### EXAMPLE

An exemplary device of the invention may be described as follows. A cable splicing support apparatus can be fabricated that has an adjustable support bar composed of a first support member and a second support member.

The second support member is a 1.5 inch by 1.5 inch square tube with multiple holes for pinning that are spaced about the tube. The first support member is inserted in the second support member and is a 1.25 inch tube with the same holes for pinning. Each of the first support member and second support member are 5 feet in length and allow the adjustable support bar to be expanded from about 5 feet to about 11 feet. By providing the adjustable bar, the apparatus may be used in different sized manholes and may be adjusted by the splicer. Moreover, the adjustable support bar, and apparatus itself, may mounted either horizontally or vertically in the manhole.

A cable splicing platform that holds and secures a cable to be spliced can be mounted on the adjustable support bar at any given point within the 5 to 11 foot length of the bar, depending upon how the bar is extended. The cable splicing platform is attached to the adjustable support bar by using a screw clamp (i.e., mounting bracket) for easy install and removal. At the other end of the cable splicing platform, opposite the screw clamp, there is a 2 inch angle (i.e., the cable holder) recessed inside of a 1.5 inch square tube that is the cable holder connector. The same type of screw clamp that is used to attach the cable splicing platform to the adjustable support bar is also attached at the 2 inch recessed angle to hold the cable to be spliced in the 2 inch angle. The tube steel that the angle is recessed into (i.e., the cable holder connector) is a 1.5 inch square tube having multiple holes for pinning. The cable holder connector is slid over a bracket arm that is welded to the mounting bracket with the bracket arm being a 1.25 inch square tube having multiple holes for pinning. The relationship between the cable holder connector and the bracket arm allows the cable holder to be rotated 90 degrees about the bracket arm. This option is used because, regardless of whether the adjustable support bar is mounted horizontally or vertically in the enclosed space, the splicer may adjust the cable splicing platform how and where the splicer needs it.

The adjustable support bar may work off of pressure, so on one end of the adjustable support bar (i.e., the first support member) has two feet on pivots that accommodate the shape of any enclosed space or manhole. The opposite end of the support bar (i.e., the second support member) has one foot on a screw (i.e., extension rod) so that when the adjustable support bar is set to the size of the enclosed space, and pins are placed in the adjustable support bar to fix the positions of the first and second support members, the splicer can screw the feet against the interior surfaces of the enclosed space by adjusting the length of the extension rod with a scaffold screw having a handle. By rotating the scaffold screw, the length of the adjustable support bar may be further increased to apply pressure in diametrically opposed directions. The application of such pressure supports the apparatus, making the apparatus self-supporting. Moreover, having two feet on one side and one foot on the other side is used to eliminate the spinning of the apparatus in the enclosed space.

This apparatus is provided in the enclosed space as an assortment of parts. The splicer may transport the apparatus in a container that includes first support member, the second support member, a support locking member in the form of two locking pins, and the cable splicing platform. This whole kit may be assembled or disassembled with the use of no tools for a simple installation.

A number of patent and non-patent publications may be cited herein in order to describe the state of the art to which this invention pertains. The entire disclosure of each of these publications is incorporated by reference herein.

While certain embodiments of the present invention have been described and/or exemplified above, various other embodiments will be apparent to those skilled in the art from the foregoing disclosure. The present invention is, therefore, not limited to the particular embodiments described and/or exemplified, but is capable of considerable variation and modification without departure from the scope and spirit of the appended claims.

Moreover, as used herein, the term “about” means that dimensions, sizes, formulations, parameters, shapes and other quantities and characteristics are not and need not be exact, but may be approximate and/or larger or smaller, as desired, reflecting tolerances, conversion factors, rounding off, measurement error and the like, and other factors known to those of skill in the art. In general, a dimension, size, formulation, parameter, shape or other quantity or characteristic is “about” or “approximate” whether or not expressly stated to be such. It is noted that embodiments of very different sizes, shapes and dimensions may employ the described arrangements.

Furthermore, the transitional terms “comprising”, “consisting essentially of” and “consisting of”, when used in the appended claims, in original and amended form, define the claim scope with respect to what unrecited additional claim elements or steps, if any, are excluded from the scope of the claim(s). The term “comprising” is intended to be inclusive or open-ended and does not exclude any additional, unrecited element, method, step or material. The term “consisting of” excludes any element, step or material other than those specified in the claim and, in the latter instance, impurities ordinary associated with the specified material(s). The term “consisting essentially of” limits the scope of a claim to the specified elements, steps or material(s) and those that do not materially affect the basic and novel characteristic(s) of the claimed invention. All apparatuses, kits, and methods described herein that embody the present invention can, in alternate embodiments, be more specifically defined by any of the transitional terms “comprising,” “consisting essentially of,” and “consisting of.”

1. A cable splicing support apparatus for securing a cable in an enclosed space, the apparatus comprising:
a. an adjustable support bar comprising:
a first support member comprising a first shaft and a first engagement portion that comprises a first foot configured to removably engage a first surface of an enclosed space;
a second support member that slidably engages with the first support member comprising a second shaft and a second engagement portion comprising a second foot configured to removably engage a second surface of an enclosed space, wherein the first engagement portion and second engagement portion are aligned in diametric opposition; and
an extension rod configured to expand the adjustable support bar and removably engage the first foot and second foot with the first and second surfaces of the enclosed space;
b. a support locking member configured to releasably lock the first and second support members in fixed engagement; and
c. a cable splicing platform engaged with at least one of the first and second support members and configured to removably secure a cable, the platform comprising a mounting bracket configured to connect with at least one of the first and second support members.

2. (canceled)

3. The support of claim 1, wherein the first engagement portion comprises a foot mounting bracket that connects the first foot to the first shaft.

4. The support of claim 3, wherein the foot mounting bracket comprises a foot pivot configured to pivotally connect the first foot to the foot mounting bracket.

5. The support of claim 1, wherein the first foot comprises a deformable pad.

6-8. (canceled)

9. The support of claim 1, wherein the extension rod is disposed at the second engagement portion and slidably connects the second foot to the second the second shaft.

10. The support of claim 9, wherein the second engagement portion comprises an extension rod locking member configured to releasably lock the second shaft and the extension rod in fixed engagement.

11-18. (canceled)

19. The support of claim 1, wherein a surface of the first or second shaft comprises a groove and the support locking member comprises a retractable pawl configured to engage with the groove.

20. The support of claim 1, wherein the support locking member comprises a locking bolt that is substantially perpendicular to a surface of the first or second shaft.

21. The support of claim 1, wherein a portion of the first or second shaft is threaded and the support locking member comprises a jack bolt.

22. The support of claim 1, wherein one of the first shaft and the second shaft comprises a plurality of apertures and the support locking member comprises a pin configured to pass through and engage at least one aperture of the plurality of apertures on one of the first shaft and the second shaft.

23. (canceled)

24. The support of claim 1, wherein the mounting bracket comprises a clamp.

25-26. (canceled)

27. The support of claim 1, wherein the platform comprises a bracket arm that connects the mounting bracket to a cable holder configured to support a cable.

28. (canceled)

29. The support of claim 1, wherein the cable splicing platform comprises a cable keeper configured to releasably secure a cable to the platform.

30. The support according to claim 29, wherein the cable keeper comprises an arm configured to confine a cable secured at the platform and further comprising a compression latch configured to releasably lock the arm.

31-36. (canceled)

37. The support of claim 1, comprising a light attached to at least one of the first and second support members.

38. (canceled)

39. The support of claim 1, comprising an adjustable tray attached to at least one of the first and second support members.

40. A cable splicing support kit having component parts capable of being assembled within an enclosed space at a cable that requires splicing for supporting the cable, the kit comprising:
a. a first support member comprising a first shaft and a first engagement portion that comprises a first foot configured to removably engage a surface of an enclosed space;
b. a second support member that is adapted to be slidably engaged with the first support member to provide an adjustable support bar, the second support member comprising a second shaft and a second engagement portion comprising a second foot adapted to removably engage a surface of an enclosed space, wherein the first engagement portion and second engagement portion are adapted to be aligned in diametric opposition;
c. an extension rod configured to expand the adjustable support bar and adapted to removably engage the first foot and second foot with the first and second surfaces of the enclosed space;
d. a support locking member adapted to releasably lock the first and second support members in fixed engagement; and
e. a cable splicing platform adapted to be engaged with at least one of the first and second support members and configured to removably secure a cable, the platform comprising a mounting bracket adapted to be connected with at least one of the first and second support members.

41. The kit of claim 40, further comprising an adjustable light adapted to be connected to at least one of the first and second support members.

42. The kit of claim 40, further comprising an adjustable tray adapted to be connected to at least one of the first and second support members.

43. A method for securing a cable in an enclosed space, the method comprising the steps of:
a. providing a cable splicing support apparatus as set forth in claim 1 proximate to a cable that requires splicing in an enclosed space;
b. expanding the cable splicing support apparatus until the first and second foot of the cable splicing support apparatus are engaged with a first and second surface of the enclosed space; and
c. securing the cable at the cable splicing platform of the cable splicing support apparatus.
